(19) United States
(12) Patent Application Publication
(10) Pub. No.: US 2011/0184882 A1
(43) Pub. Date: Jul. 28, 2011

(54) SOCIAL MODELING OF PROCESSES

(75) Inventors: David Amid, Kiryat Ata (IL); Ateret Anaby-Tavor, Givat Ada (IL); Amit Fisher, Nofit (IL); Dagan Gilat, Zichron Yaakov (IL); Segev Eliezer Wasserkrug, Haifa (IL)

(73) Assignee: International Business Machines Corporation, Armonk, NY (US)

(21) Appl. No.: 12/692,686

(22) Filed: Jan. 25, 2010

(51) Int. Cl. G06Q 10/00; G06G 7/48; G06F 12/14

(52) U.S. Cl. 705/348; 703/6; 726/4

(57) ABSTRACT

A computer implemented method for social modeling is disclosed. The method includes entering into a modeling environment one or more model elements by one or more users via communication device communicating over a communication network, performing modeling actions on the model elements, by the users according to their roles, determining if one or more of the model elements satisfy a policy, and if so determining that the policy satisfying model elements are finalized. A computer program product and a data processing system are also disclosed.

### BACKGROUND

The present invention relates to modeling. More specifically, the present invention relates to social modeling, for example, process or business process modeling. Social modeling is a modeling procedure which augments traditional modeling activity with social characteristics.

Modeling is an activity which is frequently done in an iterative mode, utilizing various techniques to obtain the information needed to conduct the modeling activity. For example, whilst business process modeling, business analysts are trying to model a process domain by employing a set of interviews, data gathering, observations, simulations and validations techniques. Most of the time this procedure is characterized by iterations carried out between the business analyst and the process stakeholders. In these iterations the business process model is reviewed, analyzed and refined based on comments from the process stakeholders, who are actively participating in the process modeling activity. These iterations usually take a lot of time and suffer from major drawbacks such as incomplete information and the necessity to understand (and approve) the full end-to-end process by the process stakeholders, which often causes conflicts and disagreements in the modeling procedure. Moreover, these modeling methods do not exploit common knowledge of the roles/users that are performing the business process beside the initial interviews and final validations.

### SUMMARY

According to embodiments of the present invention there is provided a computer implemented method for social modeling. The method includes entering into a modling environment one or more model elements by one or more users via communication device communicating over a communication network, performing modeling actions on the model elements, by the users according to their roles, determining if one or more of the model elements satisfy a policy, and if so determining that the policy satisfying model elements are finalized.

Furthermore, in accordance with embodiments of the present invention, there is provided a computer program product stored on a non-transitory tangible computer readable storage medium for social modeling. The computer program includes code for entering into a modeling environment one or more model elements by one or more users via communication device communicating over a communication network, performing modeling actions on the model elements, by the users according to their roles, determining if one or more of the model elements satisfy a policy, and if so determining that the policy satisfying model elements are finalized.

Furthermore, in accordance with embodiments of the present invention, there is provided a data processing system. The system includes a processor; a computer usable medium connected to processor, The computer usable medium contains a set of instructions for social modeling wherein the processor is designed to carry out a set of instructions including entering into a modeling environment one or more model elements by one or more users via communication device communicating over a communication network, performing modeling actions on the model elements, by the users according to their roles, determining if one or more of the model elements satisfy a policy, and if so determining that the policy satisfying model elements are finalized.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a schematic representation of a social modeling network, in accordance with embodiments of the present invention.

FIG. 2 illustrates a flow chart of a method for social modeling network, according to embodiments of the present invention.

FIG. 3 illustrates a computerized system for incorporation in a social modeling network according to embodiments of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Flowchart/s and block diagram/s in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments of the present invention relate to the process of creating an AS IS model, and may be extended to support the process of creating a TO-BE model. An AS IS model describes the current elements of the modeled body. A TO BE model illustrates the elements which describe a desired future state, usually through improvement/transformation/optimization of an AS IS process, or introduction of new ones.

While in present business process modeling procedure according to embodiments of the present invention is described by way of example, it is understood that social modeling networks may be used to model any element of a process, not just business processes, and therefore the scope of the present invention is construed to encompass any modeling activity and not just business process modeling.

In the context of the present invention the following terms are used:

1) User is an individual who can log into a social modeling system, according to the present invention.

2) Social Modeling Environment (SME) is the name denoted to the system in which a method according to embodiments of the present invention is performed.

3) User role is a role a user instance can perform. A role may be performed by many users, and user may play many roles. A role may be an entity in the Social Modeling Environment (SME), as well as an actor or participant in the models themselves.

4) Basic Elements (BE) are the building blocks of a model. Examples of BE from BPMN spec may include, business task, business process, business sub-process, gateway, split node, join node. BEs are used by the users in the process of modeling.

5) Social Decision Making Mechanism (SDMM) is a set of policies (or rules) and may be represented in the form of an algorithm that determines agreed upon entities (or model parts).

Examples are:

a. Determine the agreed upon roles.

b. Determine the agreed upon BE instances (for example, tasks and business processes in a BPMN model, or classes and associations in a UML model).

c. Determine the agreed upon relationships between BE instances. For example in a Component Business Model Map, which is a strategic map, the users may set the components and composition mechanism. A second example for a relationship between BEs is a flow that goes between two tasks in a BPMN. A third example for relationship between BEs is an event that lays on the border of a task in a BPMN.

6) Social Semantics mechanism (SSM) is a mechanism that is aimed at ensuring that the SME users will refer to agreed upon vocabulary and semantics within their modeling activities. For example, agreed terminology should be used for the different BEs or roles names. This mechanism can make use of glossary technology, naming convention and other semantic technologies. For example, users may suggest new roles, new glossary entries and new naming convention mechanism. A user may also modify these terms, vote for its accuracy “rightfulness” and merging or splitting the terms.

According to embodiments of the present invention, a set of activities may be performed in the SME for example:

a. creating new BE;

b. joining existing BEsc. modeling using BE (e.g. create/modify/delete new tasks, flow, decision points etc.);

d. providing input for model consolidation (e.g. voting);

e. providing input for Social Semantics mechanism (SSM). For example, when defining trading partners the vocabulary may define “Buyer” and “Seller” entities. The semantics will define the agreed on interpretation of a “Buyer” and “Seller” in the SME context.

f. solidifying the final model output.

A methodological framework is proposed for social-based business process modeling, according to embodiments of the present invention. The users of the social network are the people who are involved in the model domain or who are considered to be Subject Matter Experts in their relevant field. For example, the social network users may be the people who perform the model activities, the people who interact with the BE instance, the people who manage the BE instance(or part of it), or the people who have substantial experience and knowledge of the BE instance.

According to embodiments of the present invention the social networks' users are allowed to commonly create the model, leveraging their common knowledge in the domain being modeled.

A set of modeling actions to allow a community connected in a social network to commonly create models is proposed, according to embodiments of the present invention, which include the following:

Users of a social network are allowed to log into a Social Modeling Environment (SME) and use the model notations to model part of or a complete model. The SME is characterized in that all of the social network users can see a complete picture of the current model, and its variations. Users are also categorized by their ‘roles’. The roles can be predefined in the SME or be defined by the social semantic mechanism. Optionally, assigning specific user to a role can be approved by voting of the network users. Optionally, users can de divided into different authorization groups, where different authorization groups can have different editing/approving mandates. A rating system can be used to define which users should belong to which authorization groups.

Users may enter standard set of BE instances into the SME. When a user enters a new BE instance that user is defined as the “owner” of that BE instance, unless the user delegates it to another user in the community. Users may also request to be the owners of existing BE instance, a request that may need to be approved by the current BE instance owner, or by a community decision through Social Decision Making Mechanisms (SDMM), that is described below. Optionally, a BE instance may be owned by more then one owner (e.g. two users from the same role who have agreed to be the common owners of the BE instance).

Users can review the entered BE instance and create a relation, using connectors (which are also BEs). Examples for BE connectors from BPMN may be message connector and flow connector.

Users having the same role can disagree on (part or all of) the model. If this is the case, there are several alternatives for reconciliation:

The different options/variations may be defined by dedicated extensions to the model notation. The notation extension clearly defines the branching point where disagreement between users from the same role occurs. An example for such an extension in a UML(unified modeling language) diagram can be special stereotypes such as <<optional>>, <<substitution point>>, <<substitutes>>. Optionally, the semantic between these option may be XOR (exclusive or), so a resolution for the selected branch would be found using the SDMM

Users having the same role can use a voting mechanism to agree on the “right” description of their role's part in the business process.

Examples of SDMMs, according to embodiments of the present invention may include the following:

A. “Policies” are defined as structure conditions on any of the parameters and data that are kept in the SME. Examples for such data are the BE, the BE instance owners, the links between BE instances, timestamps of BE instance creation and manipulation etc.

Examples for policies may include the following rules:

1. If a BE instance A relates to a BE instance B and they have the same role owner, and there is no violation of other policies, both BE A, BE B and the relation between them are transferred into a finalized model (or state) (or a part therein, referred hereinafter as—“finalized model”).

2. if a BE instance A relates to a BE instance B and the role owner of BE A agrees to relate to BE B and vice versa, and there is no violation of other policies, both BE A, BE B and the relation between them are transferred into finalized model.

3. If a BE instance is in a “pending” model (or state) for more then a predefined time units, it is being transferred into finalized model (or state).

4. If a BE instance contains another BE instance (like in a “composed process” and “tasks” in the BPMN standard), it will be transferred into finalized model when all its contained BEs are transferred into finalized model.

B. Using rating and voting mechanisms of both roles and model elements to aggregate the social members opinions. Example for such rating or voting mechanisms may include:

1. If more then a predetermined percentage of users have rated a decision as “bad”, it can not be transferred to a finalized model.

2. If more then a predetermined percentage of users have rated a relation between BE A and BE B as “approved” the relation is transferred to a finalized model even if its owners did not agree on it (see policy above).

3. Users may be rated. Users may obtain credit when their proposed BE are transferred from a pending to a finalized model. As users get more credit, they might be promoted to a higher authorization group, thereby get more power to change or approve pending BE instances. Optionally, one can forbid a user from approving own pending BE instances.

4. If a participant (or role) is rated above a predetermined threshold, they are transferred to a higher authorization group.

C. Policies that may be overridden by “Power users”, i.e. users who are part of special authorization groups can override any policies and add/omit BE instances or relations from a finalized model.

The result of a social modeling procedure within the SME, according to embodiments of the present invention, is a set of BE instances in a finalized model, which represent the final model, as accepted.

Reference is made to the figures.

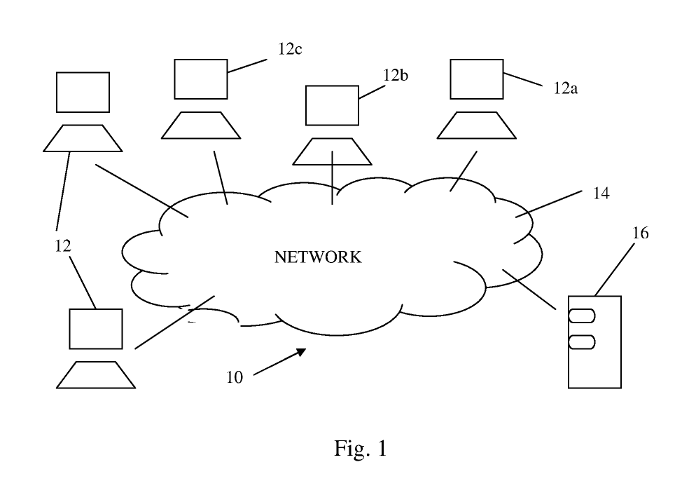

FIG. 1 illustrates a schematic representation of a social modeling network 10, in accordance with embodiments of the present invention. The social modeling network includes user devices 12, communicating over a network 14 between themselves or with server 16.

According to some embodiments of the present invention social modeling network may be materialized in the form of client-server architecture (e.g. users 12-server 16) or in the form of peer-to-peer architecture (e.g. user 12a-user 12b-user 12c).

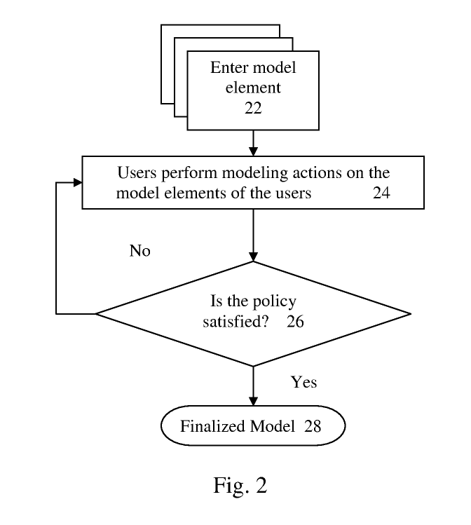

FIG. 2 illustrates a flow chart of a method for social modeling network, according to embodiments of the present invention.

A plurality of users enter, each, their model elements 22 (BE). The users then may perform modeling actions 24 according to their role with respect to these elements, as described hereinabove.

It is then determined if the policy of the social modeling network is satisfied 26 and if not the model element is subjected to further modeling actions 24. Upon determining that the policy is satisfied 26 the model element is declared a finalized model 28.

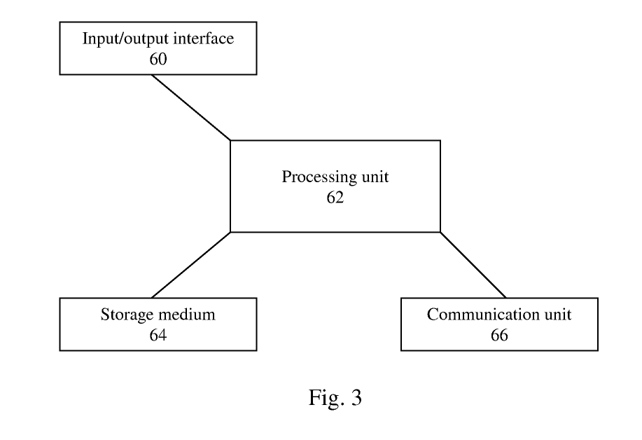

FIG. 3 illustrates a computerized system for incorporation in a social modeling network according to embodiments of the present invention.

The system, such as, for example, a computer device, may include an input/output unit 60, which may include, for example, a keyboard, a pointing device, a touch screen, a printer and a monitor. The system also includes processing unit 62, which may include a single processor or a plurality of processors, storage medium 64, which may include, for example, a hard-disk, flash memory, floppy disk, disk-on-key, on which a computer executable program may be stored, which includes instructions to perform a method according to embodiments of the present invention. A communication unit 66 may be provided for communicating with another system across a communication line or a network over communication wire or wires or wirelessly.

What is claimed is:

1. A computer implemented method for social modeling, the method comprising:
entering into a modeling environment one or more model elements by one or more users via communication device communicating over a communication network;
performing modeling actions on said one or more model elements, by the users according to their roles;
determining if one or more model elements of said one or more model elements satisfy a policy, and if so determining that said one or more policy satisfying model elements are finalized.

2. A method as claimed in claim 1, wherein the performing of modeling actions includes creating a model.

3. A method as claimed in claim 2, wherein creating the model includes using relations.

4. A method as claimed in claim 1, comprising rating by the users of acted upon model elements.

5. A method as claimed in claim 1, comprising voting by users having predefined roles on acted upon model elements.

6. A method as claimed in claim 1, wherein the policy includes one or more of the following rules:
if two or more of the entered modeling elements that were created by users having the same role are related by a relation, and no other policy rule is violated, then said two or more of the entered modeling elements are determined as finalized;
if two or more of the entered modeling elements which are entered by users having different roles are related by a relation and no other policy rule is violated and the users agrees to the connection between the model elements then said two or more of the entered modeling elements are determined as finalized;
if a model element of said one or more model elements is subjected to said modeling actions over a determined period of time it is determined as finalized;
if a model element of said one or more model elements includes one or more other modeling elements it is determined as finalized only when all of said one or more other modeling elements are determined as finalized;
if a relation between two or more of said one or more model elements is approved by a determined percentage of the users the relation is determined as finalized

7. A method as claimed in claim 1, wherein the users have different authorizations with respect to performing modeling actions.

8. A method as claimed in claim 7, wherein the users are rated and upon reaching a predetermined rate are assigned greater authorization.

9. A computer program product stored on a non-transitory tangible computer readable storage medium for social modeling, the computer program including code for
entering into a modling environment one or more model elements by one or more users via communication device communicating over a communication network;
performing modeling actions on said one or more model elements, by the users according to their roles;
determining if one or more model elements of said one or more model elements satisfy a policy, and if so determining that said one or more policy satisfying model elements are finalized.

10. A computer program product as claimed in claim 9, wherein the computer code for the performing of modeling actions modeling actions includes code for creating a model.

11. A computer program product as claimed in claim 10, wherein the code for creating the model includes code for using relations in the creating of the model.

12. A computer program product as claimed in claim 9, wherein the computer program includes code for rating by the users of acted upon model elements.

13. A computer program product as claimed in claim 9, wherein the computer program includes code for voting by users having predefined roles on acted upon model elements.

14. A computer program product as claimed in claim 9, wherein the policy includes one or more of the following rules:
if two or more of the entered modeling elements that were created by users having the same role are related by a relation, and no other policy rule is violated then said two or more of the entered modeling elements are determined as finalized;
if two or more of the entered modeling elements which are entered by users having different roles are related by a relation and no other policy rule is violated, and the users agree to the relationship between the model elements, then said two or more of the entered modeling elements are determined as finalized;
if a model element of said one or more model elements is subjected to said modeling actions over a determined period of time it is determined as finalized;
if a model element of said one or more model elements includes one or more other model elements it is determined as finalized only when all of said one or more other modeling elements are determined as finalized;
if a relation between two or more of said one or more model elements is approved by a determined percentage of the users the relation is determined as finalized

15. A computer program product as claimed in claim 9, wherein the computer program includes code for assigning the users with different authorizations with respect to performing modeling actions.

16. A computer program product as claimed in claim 9, wherein the computer program includes code for rating the users and upon a user reaching a predetermined rate assigning the user greater authorization.

17. A data processing system comprising:
a processor;
a computer usable medium connected to processor, wherein the computer usable medium contains a set of instructions for social modeling wherein the processor is designed to carry out a set of instructions including
entering into a modeling environment one or more model elements by one or more users via communication device communicating over a communication network;
performing modeling actions on said one or more model elements, by the users according to their roles;
determining if one or more model elements of said one or more model elements satisfy a policy, and if so determining that said one or more policy satisfying model elements are finalized.

18. A data processing system as claimed in claim 17, the set of instructions includes performing of modeling actions modeling actions includes code for creating a model.

19. A data processing system as claimed in claim 17, the set of instructions includes creating the model includes code for using relations.

20. A data processing system as claimed in claim 17, the set of instructions includes rating by the users of acted upon model elements.

21. A data processing system as claimed in claim 17, the set of instructions includes voting by users having the same role on acted upon model elements.

22. A data processing system as claimed in claim 17, wherein the policy includes one or more of the following rules:
if two or more of the entered modeling elements that were created by users having the same role are related by a relation, and no other policy rule is violated then said two or more of the entered modeling elements are determined as finalized;
if two or more of the entered modeling elements which are entered by users having different roles are related by a relation and no other policy rule is violated and the users agrees to the connection between the model elements then said two or more of the entered modeling elements are determined as finalized;
if a model element of said one or more model elements is subjected to said modeling actions over a determined period of time it is determined as finalized;
if a model element of said one or more model elements includes one or more other modeling elements it is determined as finalized only when all of said one or more other modeling elements are determined as finalized;
if a relation between two or more of said one or more model elements is approved by a determined percentage of the users the relation is determined as finalized

23. A data processing system as claimed in claim 17, the set of instructions includes assigning the users with different authorizations with respect to performing modeling actions.

24. A data processing system as claimed in claim 17, the set of instructions includes rating the users and upon a user reaching a predetermined rate assigning the user greater authorization.
